(19) United States
(12) Patent Application Publication
(10) Pub. No.: US 2009/0277029 A1
(43) Pub. Date: Nov. 12, 2009

(54) Electrical box template

(76) Inventor: Jon Guzallis, Niantic, CT (US)

Correspondence Address: TOBIN, CARBERRY, O'MALLEY, RILEY, SELINGER, P.C., 43 BROAD STREET, PO BOX 58, NEW LONDON, CT, 06320, US

(21) Appl. No.: 12/151,750

(22) Filed: May 7, 2008

(51) Int. Cl. G01B 1/00

(52) U.S. Cl. 33/528

(57) ABSTRACT

An electrical box template comprising a body having a front opposite a back, at least four sides, and an interior opposite an exterior. At least one interior support is coupled to the interior of the body such that the interior support is configured to operate as a handle for a user. A centering orifice is disposed centrally in the body within the interior support. The centering orifice is configured to align the electrical box template with a predetermined electrical box mounting location. At least two levels are coupled to the interior of the body, with one level positioned vertically and one level positioned horizontally on the body.

### BACKGROUND

When remodeling or constructing homes, offices and commercial buildings, electrical outlet boxes and switch boxes are installed throughout the structure. Many times the boxes are usually installed on a stud at a uniform distance from the floor and in a uniform location along the stud. Sheet rock (or drywall or other wall material) is generally installed on the walls in preparation for finishing the rooms. When the sheet rock is installed the boxes are then covered. The builder must then make an opening in the sheet rock and cut the opening appropriately for installing the outlets or switches within the boxes.

When the builder begins to shape the opening for receiving the outlets or switches, the builder spends time shaving away at the opening to make the appropriate shape. This takes time and effort to match the shapes. Likewise, if the builder is not skilled, mistakes can happen causing the opening to be larger than the box, off center from the box, or smaller than the box. In each of these situations, the builder needs to spend time and money to repair the mistake.

The prior art discloses a template for scribbing electrical box openings in a wall in U.S. Pat. No. 6,434,848. This device is utilized with old work boxes mounted directly to the drywall with vertical and horizontal levels. However, the user cannot center the box over the desired location.

What is needed in the art is an electrical box template that is sized appropriate, aids in assuring alignment of the opening, and provides a centering point for proper location of the opening.

### SUMMARY

The following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. Its sole purpose is to present some concepts of the present disclosure in a simplified form as a prelude to the more detailed description that is presented herein.

The disclosure is directed toward an electrical box template. The electrical box template comprises a body having a front opposite a back, at least four sides, and an interior opposite an exterior. At least one interior support is coupled to the interior of the body such that the interior support is configured to operate as a handle for a user. A centering orifice is disposed centrally in the body within the interior support. The centering orifice is configured to align the electrical box template with a predetermined electrical box mounting location. At least two levels are coupled to the interior of the body, with one level positioned vertically and one level positioned horizontally on the body.

A method of utilizing an electrical box template is disclosed. The method comprises placing the electrical box template on a surface. The electrical box includes a body having a front opposite a back, at least four sides, and an interior opposite an exterior, at least one interior support coupled to the interior of the body that is configured to operate as a handle for a user, a centering orifice disposed centrally in the body within the interior support such that the centering orifice is configured to align the electrical box template with a predetermined electrical box mounting location, and at least two levels coupled to the interior of the body, with one level positioned vertically and one level positioned horizontally on the body. The method also comprises aligning the centering orifice with the predetermined electrical box mounting location such that the predetermined electrical box mounting location is visible through the centering orifice. The user then rotates the electrical box template to align the electrical box template to a spirit level of the at least two levels. Next, the user traces the exterior of the electrical box template with a writing implement and removes the electrical box template from the surface.

### BRIEF DESCRIPTION OF THE FIGURES

Referring now to the figures, wherein like elements are numbered alike:

FIG. 1 is a perspective view of an exemplary embodiment of the electrical box template;

FIG. 2 is a front view of an exemplary embodiment of the electrical box template; and

FIG. 3 is a perspective view of an exemplary embodiment of the use of the electrical box template with a wall and an electrical box.

### DETAILED DESCRIPTION

Persons of ordinary skill in the art will realize that the following disclosure is illustrative only and not in any way limiting. Other embodiments of the disclosure will readily suggest themselves to such skilled persons having the benefit of this disclosure.

The present disclosure is an electrical box template that can be utilized to accurately position an opening in a wall for an electrical box. The template is positioned centrally in the desired location using the centering orifice and levels the electrical box template using the levels. The user can then trace around the exterior of the electrical box template, marking the shape on the wall. The user can then cut out the shape for accessing the electrical box disposed in the interior of the wall.

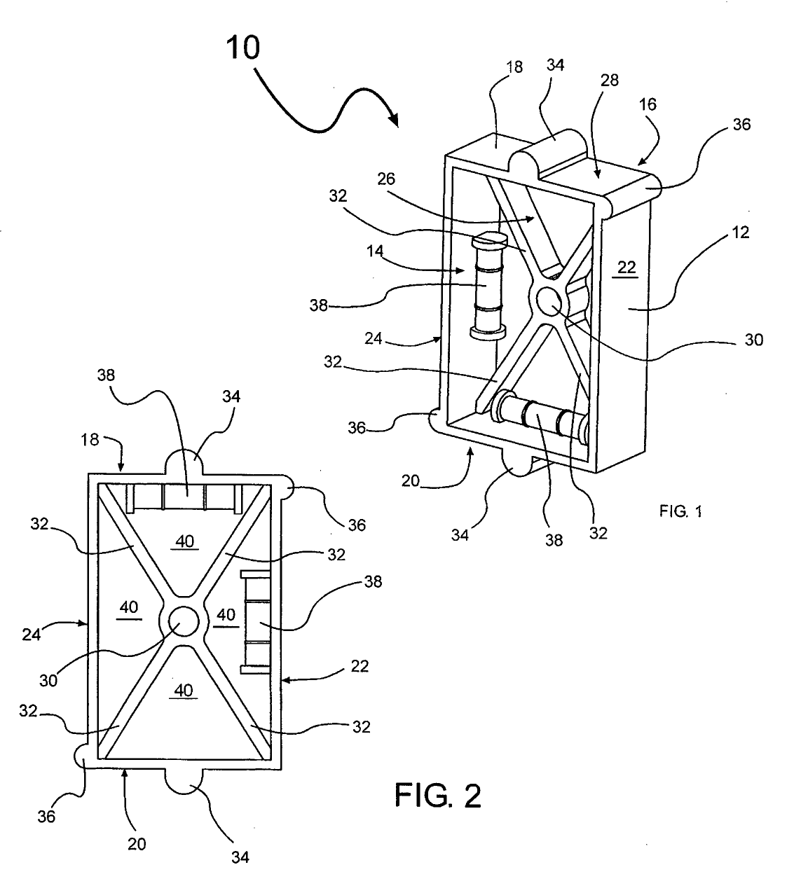

Referring to FIGS. 1 and 2, a perspective front view of an exemplary electrical box template 10 is illustrated in FIG. 1 and a front view of the electrical box template 10 is illustrated in FIG. 2. The electrical box template 10 includes a body 12 having a front 14 opposite a back 16, a first side 18 opposite a second side 20, a third side 22 opposite a fourth side 24, and an interior 26 opposite and exterior 28. A centering orifice 30 is located in the body 12, preferably in the center of the body 12. Interior supports 32 are diagonally positioned in the interior 26 of the body 12 and are configured to house the centering orifice 30.

The body 12 has alignment protrusions 34 extending from the first side 18 and the second side 20 with projections 36 extending from the corner of the first side 18 and the third side 22 and the corner of the second side 20 and the fourth side 24.

The centering orifice 30 is centrally located in the electrical box template 10 for positioning purposes. The centering orifice 30 is essentially an opening in the body 12 that extends from the front 14 to the back 16 of the body 12. The centering orifice 30 can be used to see a measurement location or to place an implement (i.e., pencil, screwdriver, etc.) through. The centering orifice 30 is also located centrally of the interior supports 32. In a preferred embodiment, the interior supports 32 extend from the corners of the interior 26 of the electrical box template 10 towards the centrally located centering orifice 30. The interior supports 32 form an “X” leaving voids 40 for the user to position his/her fingers around the centering orifice 30 (i.e., like a handle) and along the interior supports 32 for locating the appropriate measurement location on the wall 44 and for leveling the electrical box template 10. Although four interior supports 32 are illustrated, it is contemplated to have at least one interior support 32. The interior supports 32 can operate as a handle for the user when utilizing the electrical box template 10.

The alignment protrusions 34 are configured to coincide with the holes on an electrical box located within the interior of the wall. The location of the alignment protrusions 34 match the location of holes to which an outlet, for example, would be attached with an appropriate attachment means (e.g., a screw). The projections 36 are configured to coincide with the holes on an electrical box that can be coupled to another electrical box to create a series of electrical boxes coupled together (i.e., gangable). Similar to the alignment protrusions 34, the locations of the projections 36 match the holes for attaching the electrical box to another electrical box.

The levels 38 are coupled to the interior 26 of at least two of the side walls 18, 20, 22, and 24. Preferably, at least one level 38 is coupled in a vertical position and another level 38 is coupled in a horizontal position. The positioning of the levels 38 is designed for centering the template in the proper location. The levels 38 can be any conventional level that is easily read and can be easily installed in the interior 26 of the electrical box template 10.

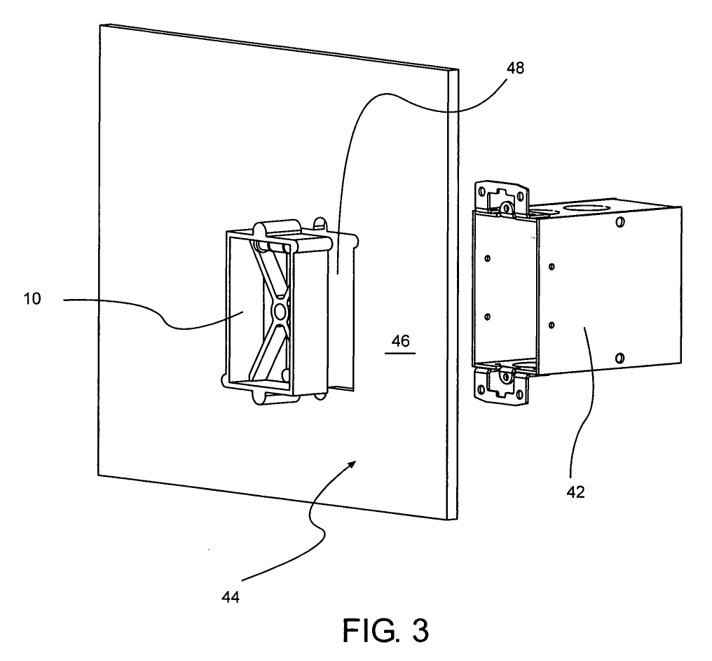

The electrical box template 10 is shaped to resemble the opening of a conventional electrical box (see FIG. 3) and preferably of similar size. In a preferred embodiment, the electrical box template 10 is about 2 inches in width and about 3 inches in length. The electrical box template 10 should be thick enough to house the levels, with a preferred thickness of about ½ inch to about 1 inch. The electrical box template 10 can be comprised of any sturdy material including, but not limited to, plastic, metal, wood, composites, and combinations thereof, and the like. It is contemplated that the electrical box template 10 is comprised on one piece of material with appropriate areas (i.e., voids, centering orifice, etc.) cut out and levels separately attached.

In use, the user (i.e., builder, homeowner, handyman, etc.) measures the appropriate distance from the floor and from the side to acquire a measurement location (or chamfer or predetermined electrical box mounting location). The measurement location denotes the position of the electrical box 42 in the interior of the wall 44 behind the wall material 46. The user then positions the electrical box template 10 against the wall 44. The user lines up the measurement location in the centering orifice 30 so that the measurement location is visible to the user. The user then rotates the electrical box template 10 while noting the readings of the levels 38 to correctly center the electrical box template 10 on the wall. The user can rotate the electrical box template 10 by holding the exterior of the electrical box template 10 or by gripping the interior supports 32 that can act as handles. The user then traces with a writing implement (i.e., pencil, pen, and the like) around the exterior 28 of the electrical box template 10. After removing the electrical box template 10 from the wall 44, the user cuts out the wall material 46 to reveal a cutout 48 that properly matches the electrical box 42. Although a wall 44 is described it is contemplated that the electrical box template 10 can be utilized with any surface (i.e., walls, floors, ceilings, and the like) that requires an opening for an electrical box 42.

The electrical box template 10 is lightweight, easily used and can fit in any conventional tool belt or tool box. The user can utilize the opening for centering of the electrical box template 10 to achieve a properly positioned opening every time.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings without departing from the essential scope thereof. Therefore, it is intended that the disclosure not be limited to the particular embodiment disclosed as the best mode contemplated for carrying out this disclosure.

What is claimed is:

1. An electrical box template comprising:
a body having an open front portion opposite a back, at least four sides, and an interior opposite an exterior;
at least one interior support coupled to said interior of said body adjacent said back, said at least one interior support configured to operate as a handle for a user;
a centering orifice disposed centrally in said body within said at least one interior support, said centering orifice configured to align the electrical box template with a predetermined electrical box mounting location; and
at least two levels coupled to said interior of said body.

2. The electrical box template of claim 1, further comprising: at least one alignment protrusion integral with at least one said side of said body and positioned on said exterior.

3. The electrical box template of claim 1, further comprising:
at least one projection integral with at least one said side of said body and positioned on said exterior to be in proximity to an intersection of two of said at least four sides.

4. The electrical box template of claim 1, wherein said centering orifice extends from said front to said back.

5. The electrical box template of claim 1, further comprising:
at least one void between said at least one interior support and at least one said side of said body.

6. The electrical box template of claim 1, wherein at least one of said levels is positioned vertically on said body and at least one of said levels is positioned horizontally on said body.

7. A method of utilizing an electrical box template comprising:
placing the electrical box template on a surface, the electrical box including a body having an open front portion opposite a back, at least four sides, and an interior opposite an exterior; at least one interior support coupled to said interior of said body adjacent said back, said at least one interior support configured to operate as a handle for a user; a centering orifice disposed centrally in said body within said at least one interior support, said centering orifice configured to align the electrical box template with a predetermined electrical box mounting location; and at least two levels coupled to said interior of said body;
aligning said centering orifice with said predetermined electrical box mounting location, wherein said predetermined electrical box mounting location is visible through said centering orifice;
rotating the electrical box template to align the electrical box template to a spirit level of said at least two levels;
tracing said exterior of said electrical box template with a writing implement; and
removing the electrical box template from said surface.

8. The method of claim 7, wherein said surface is a wall.

9. The method of claim 7, further comprising:
at least one alignment protrusion integral with at least one said side of said body and positioned on said exterior; and
at least one projection integral with at least one said side of said body and positioned on said exterior to be in proximity to an intersection of two of said at least four sides.

10. The method of claim 7, wherein said centering orifice extends from said front to said back.

11. The method of claim 7, further comprising:
at least one void between said at least one interior support and at least one said side of said body, said at least one void extending from said front to said back.

12. The method of claim 7, wherein at least one of said levels is positioned vertically on said body and at least one of said levels is positioned horizontally on said body.

13. An electrical box template comprising:
a body having a front, a back, at least four sides, an interior and an exterior;
at least one interior support connected to said interior to be adjacent said back, said at least one interior support configured to operate as a handle for a user;
a centering orifice disposed in said at least one interior support to be centrally located within said body, said centering orifice extending through said at least one interior support and configured to align the electrical box template with a predetermined electrical box mounting location; and
at least two levels coupled to said interior of said body.

14. The electrical box template of claim 13, further comprising:
at least one alignment protrusion positioned on said exterior and integral with at least one of said at least four sides.

15. The electrical box template of claim 13, further comprising:
at least one projection positioned on said exterior and integral with at least one of said at least four sides to be in proximity to an intersection of two of said at least four sides.
